(19) United States
(12) Patent Application Publication
(10) Pub. No.: US 2022/0140383 A1
(43) Pub. Date: May 5, 2022

(54) PREPARATION OF COMPOSITE SOLID ELECTROLYTE AND ALL-SOLID-STATE BATTERY USING THE SAME

(71) Applicant: Jae Kwang Kim, Cheongju-si (KR)

(72) Inventor: Jae Kwang Kim, Cheongju-si (KR)

(21) Appl. No.: 17/434,771

(22) PCT Filed: Feb. 21, 2020
(86) PCT No.: PCT/KR2020/002579

§ 371 Date: Aug. 30, 2021

(30) Foreign Application Priority Data
Mar. 5, 2019 (KR) 10-2019-0025370

(51) Int. Cl. H01M 10/056

(52) U.S. Cl. CPC H01M 10/056; H01M 2300/0071; H01M 2300/0082

(57) ABSTRACT

The present invention relates to a method for manufacturing a new type of composite solid electrolyte for improving the safety and electrochemical properties of a secondary battery, and an all-solid-state battery using the same. An ion conductive ceramic and a polymer are mixed with a solvent to make a slurry, and then a net structure is formed through electrospinning. After drying, a liquid electrolyte is absorbed into the pores to produce a composite solid electrolyte composed of a ceramic, a polymer, and a liquid electrolyte with excellent electrical conductivity. The composite solid electrolyte having such a structure can improve not only the safety of a secondary battery but also the electrochemical properties of a secondary battery.

### TECHNICAL FIELD

The present invention relates to an all-solid-state secondary battery for improving the safety of the secondary battery. The present invention is to make a film of a network structure formed by intersecting composite fibers of an ion conductive ceramic and a polymer, which are made by mixing the ion conductive ceramic and the polymer with a solvent to make a slurry and then electrospinning the slurry. The present invention also relates to a technique for making a composite solid electrolyte with high ionic conductivity by absorbing a liquid electrolyte into the film of the network structure. The all-solid-state secondary battery using this composite solid electrolyte has excellent electrochemical properties.

### BACKGROUND ART

The field of application of a secondary battery that can be rechargeable is expanding day by day, from portable devices such as mobile phones, laptops, and camcorders to electric vehicles. In general, a secondary battery consists of an anode part, a cathode part, an electrolyte, and a separator made of a polymer. The electrolyte and the separator are positioned between the cathode part and the anode part.

Currently, the most widely used secondary battery is a lithium ion secondary battery. The lithium ion secondary battery uses a liquid electrolyte, particularly an ion conductive organic liquid electrolyte in which salt is dissolved in a non-aqueous organic solvent. However, the liquid electrolyte is inherently weak against heat and shock and highly flammable. Therefore, there is a problem in that the lithium ion secondary battery explodes or burns when the secondary battery is damaged by an external shock or the temperature of the secondary battery increases.

In order to solve this problem, efforts have been made to replace the liquid electrolyte with a solid electrolyte such as a ceramic solid electrolyte or a polymer electrolyte. However, this solid electrolyte has low ionic conductivity at room temperature and high interfacial resistance with electrodes although it has high stability, thereby degrading the electrochemical properties of the secondary battery.

In order to solve this problem of the solid electrolyte, there is an attempt to make a composite solid electrolyte by mixing a ceramic and a polymer as shown in FIG. 1 or by mixing a ceramic, a polymer, and a liquid electrolyte and place it between electrodes.

However, this solid electrolyte has low electrochemical properties due to its high interfacial resistance. A composite solid electrolyte in which an organic material and an inorganic material are mixed has lower interfacial resistance than the solid electrolyte, but still has a high interfacial resistance. The composite solid electrolyte has a problem in that it has low high-rate characteristics and low lifespan characteristics.

### DISCLOSURE

### Technical Problem

The present invention is to improve the electrochemical properties of the composite electrolyte by making a fiber-type composite film with a high porosity, in which an ion conductive ceramic and a polymer are mixed, by an electrospinning method using a mixture of the ion conductive ceramic and the polymer with the content of the ion conductive ceramic is high in order to solve the problems of the existing composite electrolyte. The present invention is to improve the electrochemical properties of the composite electrolyte by increasing the porosity of the fiber-type composite film, in which an ion conductive ceramic and a polymer are mixed, by electrospinning method using a mixture of the ion conductive ceramic and the polymer with the content of the ion conductive ceramic is high and filling the pores with a liquid electrolyte in order to solve the problems of the existing composite electrolyte.

### Technical Solution

An all-solid-state secondary battery made of a solid electrolyte or a composite solid electrolyte has excellent safety, but have high interfacial resistance and low high-rate characteristics and low lifespan characteristics, making it difficult to replace a liquid electrolyte. The present invention is to prepare a composite solid electrolyte with high ionic conductivity by making a composite film in the form of fibers in which an ion conductive ceramic and a polymer are mixed through an electrospinning method and absorbing a liquid electrolyte in the pores between these fibers in order to improve the interfacial resistance, high-rate characteristics, and lifespan characteristics of an all-solid-state secondary battery. The ion conductive ceramic is used in large amounts (>60% by weight), and the polymer is used in small amounts (<40% by weight). The composite solid electrolyte produced in this way has a high porosity because a large amount of the ion conductive ceramic and a small amount of the polymer form fibers and the fibers form a network structure film. The liquid electrolyte filled in this pore can improve the electrochemical properties of the all-solid-state battery by reducing the interfacial resistance between the ceramics and the interfacial resistance between the electrode and the composite solid electrolyte.

### Advantageous Effects

The composite film made of the composite fibers of a ceramic and a polymer made by the electrospinning method according to the present invention has a high porosity and is advantageous in reducing the interfacial resistance.

The composite film made of the composite fibers of a ceramic and a polymer made by electrospinning according to the present invention has a high porosity and therefore can absorb a sufficient liquid electrolyte. As a result, electrochemical characteristics such as charging speed and lifespan characteristics of an all-solid-state secondary battery can be improved.

### DESCRIPTION OF DRAWINGS

FIG. 1 is a conventional composite solid electrolyte made by mixing a ceramic and a polymer.

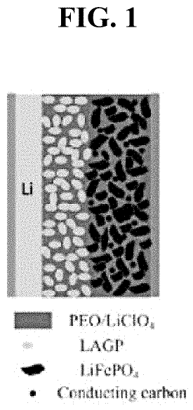

FIG. 2 is a schematic view of a composite solid electrolyte in the form of a nonwoven fabric film formed by gathering fibers made of an ion conductive ceramic and a polymer.

FIG. 3 shows a method for preparing a composite solid electrolyte in the form of a nonwoven fabric by electrospinning a composite fibers of an ion conductive ceramic and a polymer.

FIG. 4 is a SEM image of a composite film in the form of a non-woven fabric made of composite fibers of an ion conductive ceramic and a polymer. The left is a SEM image of a composite film in the form of a non-woven fabric composed of LAGP and PNA composite fibers, and the right is a SEM image of a composite film in the form of a non-woven fabric composed of LATP and PVdF composite fibers.

FIG. 5 is a TEM image of a composite film in the form of a non-woven fabric made of composite fibers of an ion conductive ceramic (LAGP) and a polymer (PAN).

FIG. 6 is a cross-sectional SEM image taken after compressing a composite film composed of composite fibers of 80% by weight of LAGP and 20% by weight of PAN.

FIG. 7 is a graph of ionic conductivity vs. temperature of a composite solid electrolyte made by absorbing 100% by weight of a liquid electrolyte (1M LiPF₆ in EC/DEC) into a composite film composed of composite fibers of 80% by weight of LAGP and 20% by weight of PAN.

FIG. 8 is a charge-discharge graph of a secondary battery composed of a LiFePO₄ positive electrode, a lithium negative electrode, and a composite solid electrolyte prepared by absorbing 100% by weight of a liquid electrolyte (1M LiPF₆ in EC/DEC) into a nonwoven fabric composite film composed of composite fibers 80% by weight of LAGP and 20% by weight of PAN.

FIG. 9 is a charge-discharge graph of a secondary battery composed of a LiFePO₄ positive electrode, a lithium negative electrode, and a composite solid electrolyte prepared by absorbing 120% by weight of a liquid electrolyte (1M LiPF₆ in EC/DEC) into a nonwoven fabric composite film composed of composite fibers 80% by weight of LATP and 20% by weight of PVdF.

FIG. 10 is a graph of a discharge capacity of a composite solid electrolyte of the present invention and the commercialized liquid electrolyte measured according to the number of cycles at 80° C. and at 0.1 C rate (discharge rate).

### BEST MODE FOR INVENTION

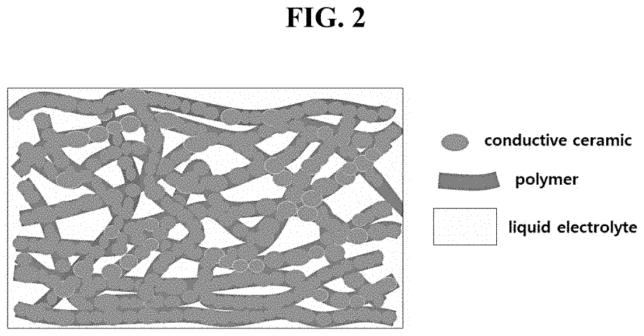

FIG. 2 is a schematic diagram of a composite solid electrolyte in which a liquid electrolyte is absorbed after fabricating a non-woven fabric composite film formed by intersecting fibers made of an ion conductive ceramic and a polymer using electrospinning.

The ion conductive ceramic used for manufacturing fibers made of an ion conductive ceramic and a polymer using electrospinning may be a lithium oxide ceramic containing oxygen in the crystal structure such as β-Al₂O₃, (La,Li)TiO₃ (LLTO) ((La,Li)=La or Li), Li₅La₃Ta₂O₁₂, Li₆La₂CaTa₂O₁₂, Li₄SiO₄, Li₃BO_{2.5}N_{0.5}, Li₉SiAlO, Li₆La₂ANb₂O₁₂ (A=Ca or Sr), Li₂Nd₃TeSbO₁₂, Li₇La₃Zr₂O₁₂ (LLZO), Li₅La₃Ta₂O₁₂, and Li₉SiAlO₈, a lithium sulfide ceramic containing sulfur in the crystal structure such as Li₁₀GeP₂S₁₂, Li₇P₂S₁₁, Li_{3.25}Ge_{0.25}P_{0.75}S₄ (LGPS), Li₂S—Si₂S₅, Li₂S—Ga₂S₃—GeS₂, Li₂S—Sb₂S₃—GeS₂, Li₂S—P₂S₅, Li₂S—P₂S₅—Li₄SiO₄, and Li_{3.25}—Ge_{0.25}—P_{0.75}S₄(Thio-LISICON), a lithium phosphate ceramic containing phosphorus in the crystal structure such as LAGP (Li₁₊ₓAlₓGe₂₋ₓ(PO₄)₃) (0<x<2, preferably 0<x<1), LTAP (Li₊ₓTi₂₋ₓAlₓ(PO₄)₃) (0<x<2, preferably 0<x<1), Li₁₊ₓTi₂₋ₓAlₓSi_{y}(PO₄)_{3-y} (0<x<2, 0<y<3, preferably 0<x<1, 0<y<1), LiAlₓZr₂₋ₓ(PO₄)₃ (0<x<2, preferably 0<x<1), and LiTiₓZr₂₋ₓ(PO₄)₃ (0<x<2, preferably 0<x<1), an amorphous ion conductive ceramic such as phosphorous-based glass, oxide-based glass, and oxide-sulfide-based glass, NASICON, a sodium sulfide ceramic, a sodium oxide ceramic such as Na₃Zr₂Si₂PO₁₂, or a combination thereof.

The polymer used for manufacture fibers made of an ion conductive ceramic and a polymer using electrospinning may be polyvinylidene fluoride (PVdF)-based polymer or its copolymer, poly[(vinylidene fluoride-co-trifluoroethylene]-based polymer or its copolymer, polyethylene glycol (PEO)-based polymer or its copolymer, poly acrylonitrile (PAN)-based polymer or its copolymer, poly(methyl methacrylate) (PMMA)-based polymer or its copolymer, polyvinyl chloride-based polymer or its copolymer, polyvinylpyrrolidone (PVP)-based polymer or its copolymer, polyimide (PI)-based polymer or its copolymer, polyethylene (PE)-based polymer or its copolymer, polyurethane (PU)-based polymer or its copolymer, polypropylene (PP)-based polymer or its copolymer, poly(propylene oxide) (PPO)-based polymer or its copolymer, poly(ethylene imine) (PEI)-based polymer or its copolymer, poly(ethylene sulfide) (PES)-based polymer or its copolymer, poly(vinyl acetate) (PVAc)-based polymer or its copolymer, poly(ethylene succinate) (PESc)-based polymer or its copolymer, polyester-based polymer or its copolymer, polyamine-based polymer or its copolymer, polysulfide-based polymer or its copolymer, siloxane-based polymer or its copolymer, styrene butadiene rubber (SBR)-based polymer or its copolymer, or carboxymethyl cellulose (CMC)-based polymer or its copolymer, or a derivative thereof, or a combination thereof.

The solvent used to mix the ion conductive ceramic and the polymer may be DMF (dimethylformamide), NMP (N-methyl-2-pyrrolidone), N,N-dimethylacetamide (DMAc), acetone, ethanol, methanol, butanol, distilled water, dimethyl carbonate (DMC), tetrahydrofuran (THF), hexanol, chloroform, diethylcarbonate (DEC), or a derivative thereof, or a combination thereof.

The liquid electrolyte to be absorbed into the composite film made of the composite fibers of the ion conductive ceramic and the polymer may be a lithium salt or sodium salt dissolved in a non-aqueous organic solvent, an ionic liquid solvent, or a mixture thereof, but is not limited thereto. All kinds of liquid electrolytes commonly used in the art may be included. The non-aqueous organic solvent may be a carbonate-based non-aqueous organic solvent, an ester-based non-aqueous organic solvent, an ether-based non-aqueous organic solvent, a ketone-based non-aqueous organic solvent, an alcohol-based non-aqueous organic solvent, a phosphate-based non-aqueous organic solvent, an aprotic solvent, or a combination thereof. The ionic liquid solvent may be an ionic liquid solvent of cation of imidazolium, pyridinium, pyrrolidinium, sulfonium, pyrazolium, ammonium, morpholinium, phosphonium, piperidinium or a combination thereof.

A lithium salt used in the liquid electrolyte may be LiClO₄, LiPF₆, CF₃SO₂NLiSO₂CF₃ (LiTFSI), Li[N(SO₂F)₂] (LiFSI), Li[B(C₂O₄)₂] (LiBOB), LiBF₄, LiAsF₆, lithium fluorosulfonyl-(trifluoromethanesulfonyl)imide (LiFTFSI) or a combination thereof. The sodium salt used in the liquid electrolyte may be NaClO₄, NaPF₄, NaBF₄, NaPF₆, NaAsF₆, NaTFSI, Na[(C₂F₅)₃PF₃] (NaFAP), Na[B(C₂O₄)₂] (NaBOB), Na[N(SO₂F)₂] (NaFSI), NaBeti(NaN[SO₂C₂F₅]₂), or a combination thereof.

The amount of the ion conductive ceramic in the mixed slurry of the ion conductive ceramic and the polymer may be 60 wt % to 90 wt %, preferably 70 wt % to 80 wt %.

The amount of the polymer in the mixed slurry of the ion conductive ceramic and the polymer may be 10 wt % to 40 wt %, preferably 20 wt % to 30 wt %.

The amount of the liquid electrolyte absorbed in the nonwoven fabric film made of the fibers of the ion conductive ceramic and the polymer may be 50 wt % to 300 wt %, preferably 60 wt % to 200 wt % based on the total weight of the ion conductive ceramic and the polymer.

The porosity of the film made by electrospinning in the form of a nonwoven fabric made of the ion conductive ceramic and the polymer may be 50% to 300%, preferably 80% to 200%.

The porosity is calculated by n-butanol absorption method in which a nonwoven fabric film is immersed in n-butanol for 1 hour. The formula for calculating the porosity is as shown in Formula 1 below.

$$P ( \% ) = \frac{{M}_{BuOH} / {ρ}_{BuOH}}{( {M}_{BuOH} / {ρ}_{BuOH} ) + ( {M}_{m} / {ρ}_{P} )} \times 100 \qquad [ Formula 1 ]$$

In Formula 1, P is the porosity, M_{BuOH} is the absorbed weight of n-butanol, P_{BuOH} is the density of n-butanol, Mₘ is the weight of the dried nonwoven fabric film, and ρ_{P} is the density of the polymer.

The thickness of the nonwoven fabric film may be 20 to 100 μm.

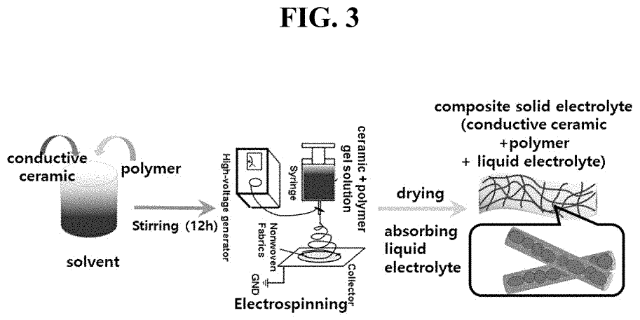

FIG. 3 is a process for manufacturing a composite solid electrolyte in the form of a nonwoven fabric using electrospinning. After evenly mixing the ion conductive ceramic and the polymer using a solvent, the slurry in the gel state is electrospun. By electrospinning, the fibers of the ion conductive ceramic and the polymer form a net-shaped nonwoven fabric film. The nonwoven fabric film is dried for 24 hours to remove the solvent, and the liquid electrolyte is absorbed into the nonwoven fabric film in an inert atmosphere to prepare the composite solid electrolyte. By electrospinning, the fibers of the ion conductive ceramic and the polymer form a net-shaped nonwoven fabric film. The nonwoven fabric film is dried for 24 hours to remove the solvent, and the liquid electrolyte is absorbed into the nonwoven fabric film in an inert atmosphere to prepare a composite solid electrolyte.

For the convenience of the process, a composite solid electrolyte in the form of a nonwoven fabric integrated with an electrode can be prepared by electrospinning a mixed solution of the ion conductive ceramic and the polymer directly on the electrode.

### Example 1

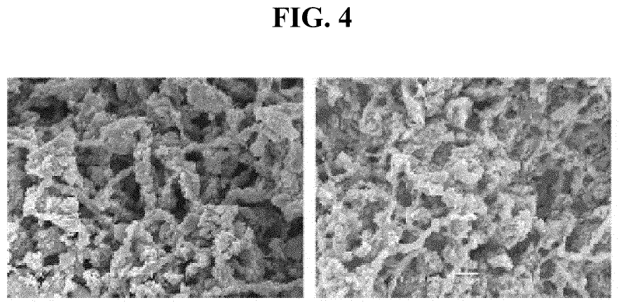

On the left of FIG. 4 is a SEM image of a nonwoven fabric film composed of composite fibers of LAGP and PAN, which was prepared by mixing 80% by weight of the ion conductive ceramic LAGP and 20% by weight of the polymer PAN in a DMF solvent to form a slurry, electrospinning the slurry, and drying the solvent. On the right of FIG. 4 is a SEM image of a nonwoven fabric film composed of composite fibers of LATP and PVdF, which was prepared by mixing 80% by weight of the ion conductive ceramic LTAP and 20% by weight of the polymer PVdF in a mixed solvent of DMAc and acetone to form a slurry, electrospinning the slurry, and drying the solvent. The porosity was 130%.

### Example 2

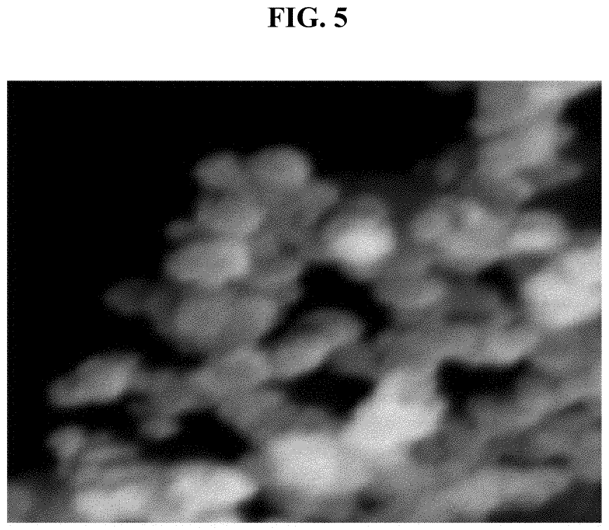

A TEM image of the composite fiber of 80 wt % of LAGP and 20 wt % of PAN prepared in Example 1 was shown in FIG. 5.

### Example 3

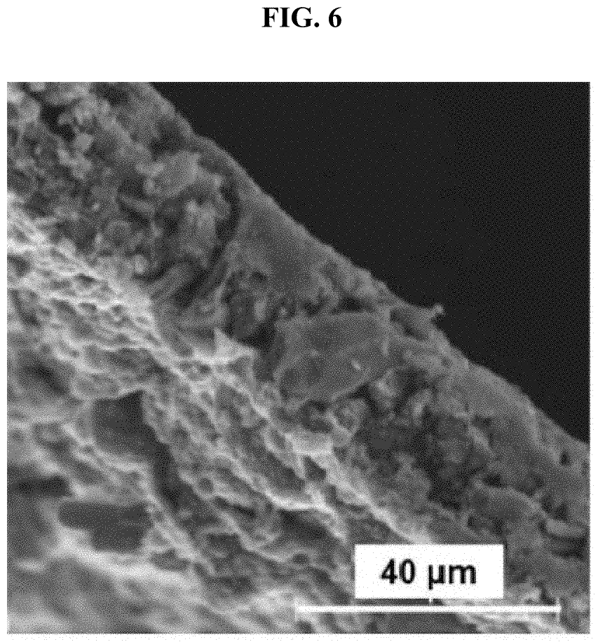

FIG. 6 shows a cross-sectional SEM image after compressing the composite film made of composite fibers of 80% by weight of LAGP and 20% by weight of PAN made in Example 1 at a pressure of 1 ton. The thickness was about 40 μm.

### Example 4

The process for producing a composite solid electrolyte by electrospinning is as follows. The powders of the ion conductive ceramic and the polymer are vacuum-dried at 100° C. or higher for at least one hour. Put the dried ceramic and polymer in a solvent (DMF) and mix. The mixed solution is placed in a syringe with a 0.6 mm diameter needle and compressed at a rate of 0.1 ml per minute. The voltage applied for the electrospinning is 18 kV. The solvent is completely removed by drying the electrospun and collected composite fiber film at 60° C. or higher for at least 12 hours.

### Example 5

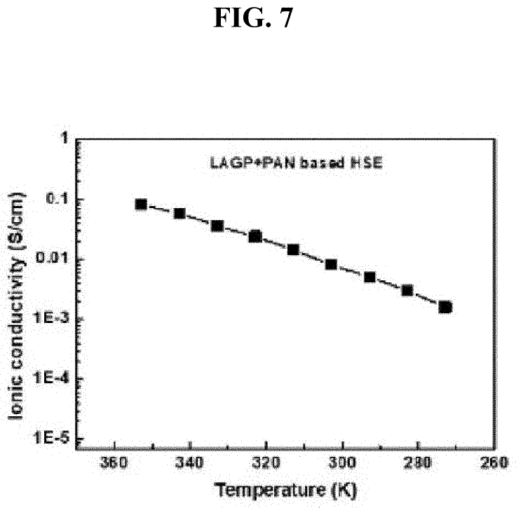

A composite solid electrolyte was prepared by absorbing 100% by weight of a liquid electrolyte (1M LiPF₆ in EC/DEC) into a composite film composed of 80% by weight of LAGP and 20% by weight of PAN. FIG. 7 is a graph showing the ion conductivity of the composite solid electrolyte vs. temperature. The ion conductivity was 9×10⁻³ S/cm at 30° C., which was high.

### Example 6

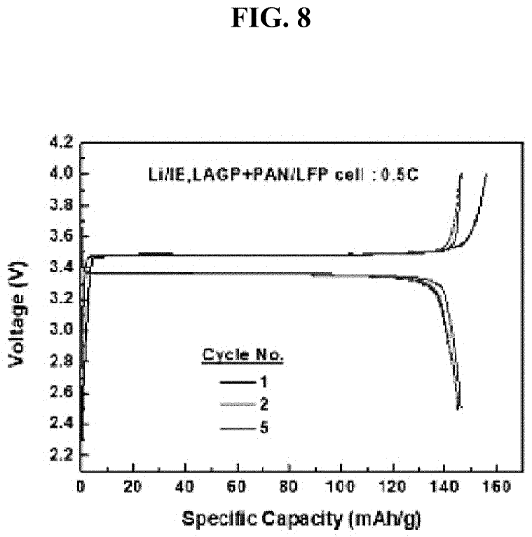

A composite solid electrolyte was prepared by absorbing 100% by weight of a liquid electrolyte (1M LiPF₆ in EC/DEC) into a composite film composed of composite fibers of 80% by weight of LAGP and 20% by weight of PAN. FIG. 8 shows the charge-discharge curve of the secondary battery comprised of the composite solid electrolyte, a LiFePO₄ positive electrode, and a lithium metal negative electrode. When a current density of 0.5 C was applied, it showed an initial reversible capacity of 147 mAh/g.

### Example 7

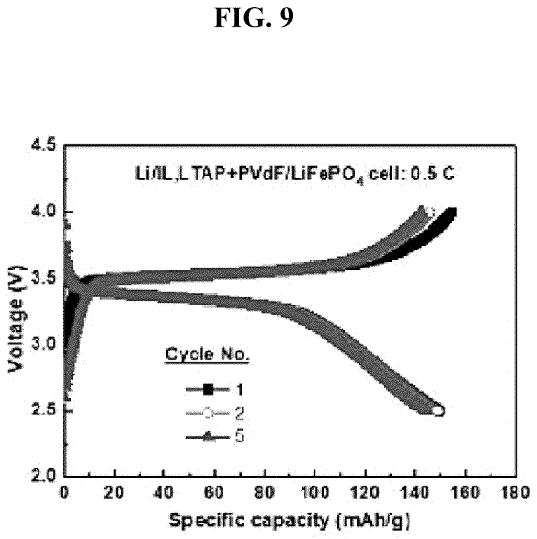

A composite solid electrolyte was prepared by absorbing 120% by weight of a liquid electrolyte (1M LiPF₆ in EC/DEC) into a composite film composed of composite fibers of 80% by weight of LATP and 20% by weight of PVdF. FIG. 9 shows the charge-discharge curve of the secondary battery comprised of the composite solid electrolyte, a LiFePO₄ positive electrode, and a lithium metal negative electrode. When a current density of 0.5 C was applied, it showed an initial reversible capacity of 152 mAh/g.

### Example 8

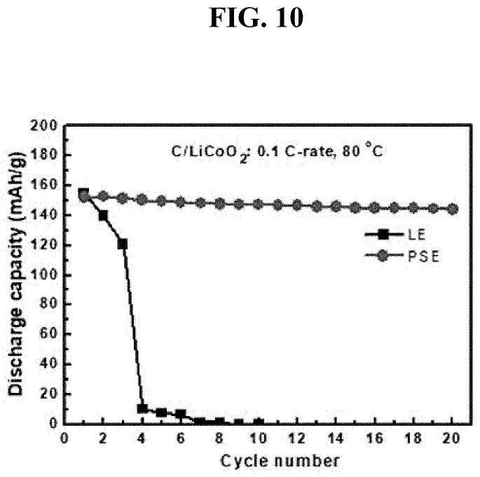

A composite solid electrolyte was prepared by absorbing 100% by weight of a liquid electrolyte (1M LiPF₆ in EC/DEC) into a composite film composed of composite fibers of 80% by weight of LAGP and 20% by weight of PAN. The discharge capacity was measured according to the number of cycles of this composite solid electrolyte and the commercial liquid electrolyte at 80° C. and at 0.1 C rate (discharge rate). The results were shown in FIG. 10. It can be seen that the commercial liquid electrolyte hardly worked at 80° C., but the composite solid electrolyte of the present invention worked well even at 80° C.

Preferred embodiments presented in the detailed description of the present invention are presented by way of example. The present invention is not limited by these embodiments. The present invention is only defined by the claims.

1. A composite solid electrolyte that is a composite film in the form of a non-woven fabric composed of composite fibers of an ion conductive ceramic and a polymer, obtained by mixing the ion conductive ceramic and the polymer using a solvent and then electrospinning the solution.

2. A composite solid electrolyte that is a composite film in the form of a non-woven fabric having a porosity of 50% to 300% composed of composite fibers of an ion conductive ceramic and a polymer, obtained by mixing the ion conductive ceramic and the polymer using a solvent and then electrospinning the solution.

3. A composite solid electrolyte produced by absorbing a liquid electrolyte into a composite film in the form of a nonwoven fabric composed of a composite fibers of an ion conductive ceramic and a polymer, obtained by mixing the ion conductive ceramic and the polymer using a solvent and then electrospinning the solution.

4. The composite solid electrolyte according to claim 1, wherein the content of the ceramic is 60% by weight to 90% by weight when the ion conductive ceramic and the polymer is taken as 100% by weight.

5. The composite solid electrolyte according to claim 1, wherein the content of the polymer is 10% by weight to 40% by weight when the ion conductive ceramic and the polymer is taken as 100% by weight.

6. The composite solid electrolyte according to claim 3, wherein the amount of the liquid electrolyte absorbed into the composite film is 50% by weight to 300% by weight when the composite film is taken as 100% by weight.

7. The composite solid electrolyte according to claim 3, wherein the absorbed liquid electrolyte is a lithium salt or sodium salt dissolved in a non-aqueous organic solvent or an ionic liquid solvent or a mixture thereof.

8. The composite solid electrolyte according to claim 7, wherein the non-aqueous organic solvent is a carbonate-based non-aqueous organic solvent, an ester-based non-aqueous organic solvent, an ether-based non-aqueous organic solvent, a ketone-based non-aqueous organic solvent, an alcohol-based non-aqueous organic solvent, a phosphate-based non-aqueous organic solvent, an aprotic solvent, or a combination thereof.

9. The composite solid electrolyte according to claim 7, wherein the ionic liquid solvent is an ionic liquid solvent of cation of imidazolium, pyridinium, pyrrolidinium, sulfonium, pyrazolium, ammonium, morpholinium, phosphonium, piperidinium or a combination thereof.

10. The composite solid electrolyte according to claim 7, wherein the lithium salt is LiClO₄, LiPF₆, CF₃SO₂NLiSO₂CF₃ (LiTFSI), Li[N(SO₂F)₂] (LiFSI), Li[B(C₂O₄)₂] (LiBOB), LiBF₄, LiAsF₆, lithium fluorosulfonyl-(trifluoromethanesulfonyl)imide (LiFTFSI) or a combination thereof.

11. The composite solid electrolyte according to claim 7, wherein the sodium salt is NaClO₄, NaPF₄, NaBF₄, NaPF₆, NaAsF₆, NaTFSI, Na[(C₂F₅)₃PF₃] (NaFAP), Na[B(C₂O₄)₂] (NaBOB), Na[N(SO₂F)₂] (NaFSI), NaBeti(NaN[SO₂C₂F₅]₂) or a combination thereof.

12. The composite solid electrolyte according to claim 1, wherein the ceramic is a lithium oxide ceramic, a lithium sulfide ceramic, a lithium phosphate ceramic, an amorphous ion conductive ceramic, NASICON, a sodium sulfide ceramic, a sodium oxide ceramic, or a combination thereof.

13. The composite solid electrolyte according to claim 12, wherein the lithium oxide ceramic is β-Al₂O₃, (La,Li)TiO₃ (LLTO) ((La,Li)=La or Li), Li₅La₃Ta₂O₁₂, Li₆La₂CaTa₂O₁₂, Li₄SiO₄, Li₃BO_{2.5}N_{0.5}, Li₉SiAlO, Li₆La₂ANb₂O₁₂ (A=Ca or Sr), Li₂Nd₃TeSbO₁₂, Li₇La₃Zr₂O₁₂ (LLZO), Li₅La₃Ta₂O₁₂, Li₉SiAlO₈, or a combination thereof.

14. The composite solid electrolyte according to claim 12, wherein the lithium sulfide ceramic is Li₁₀GeP₂S₁₂, Li₇P₂S₁₁, Li_{3.25}Ge_{0.25}P_{0.75}S₄ (LGPS), Li₂S—Si₂S₅, Li₂S—Ga₂S₃—GeS₂, Li₂S—Sb₂S₃—GeS₂, Li₂S—P₂S₅, Li₂S—P₂S₅—Li₄SiO₄, Li_{3.25}—Ge_{0.25}—P_{0.75}S₄ (Thio-LISICON), or a combination thereof.

15. The composite solid electrolyte according to claim 12, wherein the lithium phosphate ceramic is LAGP (Li₁₊ₓAlₓGe₂₋ₓ(PO₄)₃) (0<x<2), LTAP (Li₁₊ₓTi₂₋ₓAlₓ(PO₄)₃) (0<x<2), Li₁₊ₓTi₂₋ₓAlₓSi_{y}(PO₄)_{3-y} (0<x<2, 0<y<3), LiAlₓZr₂₋ₓ(PO₄)₃ (0<x<2), and LiTiₓZr₂₋ₓ(PO₄)₃ (0<x<2), or a combination thereof.

16. The composite solid electrolyte according to claim 12, wherein the amorphous ion conductive ceramic is a phosphorous-based glass, oxide-based glass, or oxide-sulfide-based glass.

17. The composite solid electrolyte according to claim 12, wherein the sodium sulfide ceramic is Na₁₀GeP₂S₁₂, Na₇P₂S₁₁, Na_{3.25}Ge_{0.25}P_{0.75}S₄, Na₂S—Si₂S₅, Na₂S—Ga₂S₃—GeS₂, Na₂S—Sb₂S₃—GeS₂, Na₂S—P₂S₅, Na₂S—P₂S₅—Na₄SiO₄, Na_{3.25}—Ge_{0.25}—P_{0.75}S₄, or a combination thereof.

18. The composite solid electrolyte according to claim 12, wherein the sodium oxide ceramic is Na₃Zr₂Si₂PO₁₂.

19. The composite solid electrolyte according to claim 1, wherein the polymer is polyvinylidene fluoride (PVdF)-based polymer or its copolymer, poly[(vinylidene fluoride-co-trifluoroethylene]-based polymer or its copolymer, polyethylene glycol (PEO)-based polymer or its copolymer, poly acrylonitrile (PAN)-based polymer or its copolymer, poly(methyl methacrylate) (PMMA)-based polymer or its copolymer, polyvinyl chloride-based polymer or its copolymer, polyvinylpyrrolidone (PVP)-based polymer or its copolymer, polyimide (PI)-based polymer or its copolymer, polyethylene (PE)-based polymer or its copolymer, polyurethane (PU)-based polymer or its copolymer, polypropylene (PP)-based polymer or its copolymer, poly (propylene oxide) (PPO)-based polymer or its copolymer, poly(ethylene imine) (PEI)-based polymer or its copolymer, poly(ethylene sulfide) (PES)-based polymer or its copolymer, poly(vinyl acetate) (PVAc)-based polymer or its copolymer, poly (ethylene succinate) (PESc)-based polymer or its copolymer, polyester-based polymer or its copolymer, polyamine-based polymer or its copolymer, polysulfide-based polymer or its copolymer, siloxane-based polymer or its copolymer, styrene butadiene rubber (SBR)-based polymer or its copolymer, or carboxymethyl cellulose (CMC)-based polymer or its copolymer, or a derivative thereof, or a combination thereof.

20. The composite solid electrolyte according to claim 1, wherein the thickness was adjusted to 20 to 100 μm by compression after making the composite film of the ion conductive ceramic and the polymer.

21. A secondary battery using the composite solid electrolyte of claim 1.

22. A secondary battery in which a non-woven composite film is integrated with an electrode by electrospinning a mixed solution of an ion conductive ceramic and a polymer directly on the electrode.
